(19) United States
(12) Patent Application Publication
(10) Pub. No.: US 2010/0135011 A1
(43) Pub. Date: Jun. 3, 2010

(54) PEST AND VANDAL RESISTANT SOLID STATE LUMINAIRE

(76) Inventor: Ben Osman RICHARDSON, Nashua, NH (US)

Correspondence Address: Ben Osman Richardson, 8 Calais Street, Apt. 2, Nashua, NH, 03060, US

(21) Appl. No.: 12/327,619

(22) Filed: Dec. 3, 2008

(51) Int. Cl. F21V 29/00

(52) U.S. Cl. 362/234

(57) ABSTRACT

The present invention provides a light emitting fixture or luminaire that is sealed from the outside and possesses no major voids within. This arrangement protects the light emitting elements, in a preferred embodiment consisting of Light Emitting Diodes (LEDs) from the elements as well as keeping pests and vandals from inhabiting and/or causing damage to the luminaire. The light emitting elements have lenses that add high impact resistance, thus improving safety and reliability. The luminaire is easy and quick to install; it can be installed using only one hand tool, and can easily be handled with thick gloves.

### BACKGROUND

The present invention pertains to the field of outdoor lighting in particular to roadway and outdoor luminaires for space lighting.

Recent increases in energy costs have driven a need for more energy and maintenance efficient devices. This includes applications for lighting fixtures in the general illumination outdoor market, including but not limited to roadway and outdoor space lighting. In addition to being energy efficient, Light Emitting Diodes LED's are more maintenance efficient in that they possess higher inherent reliability. This effectively lowers the Mean Time Between Failure (MTBF) when compared to legacy High Intensity Discharge (HID), incandescent, and fluorescent lighting filament components. However, simply swapping out one for the other is not a practical solution in most cases. The outer housing, optics, and support circuitry is as important as the LEDs themselves in providing a total support solution for both the maintainer and end user.

Life Cycle Costing (LCC) analyses show that maintenance actions usually count for some of the highest cost drivers, if not the single highest cost driver in supporting a given system over time. Such is also true for outdoor lighting systems. It is therefore desirable to have a lighting system with the highest possible reliability without adding significant per unit cost.

Current electrical factors that cause outdoor light systems to fail include but are not limited to; failure of the bulb filament itself, failure of the ballast and support circuitry, failure of the photocontrol, and failure of the transformer. Other factors include but are not limited to; weather related destruction such as damage caused by hurricanes and tornados, pest infestation—such as squirrels chewing through wires, and vandals—such as people shooting air guns or throwing rocks for the purpose of intentional destruction of lamp fixtures. All of these factors contribute to reducing the operational availability of the given population of lights that maintainers must support. The present invention addresses these issues.

A typical roadway or similar outdoor luminaire includes, among other things, of a house, a lamp providing illumination, and a means of attaching the housing to a pole or other structure to elevate the luminaire above the roadway, parking lot, or similar area to be illuminated.

One conventional approach is to use a luminaire known as a “cobra head” due to its reptilian shape. FIG. 1 shows a side view of a typical prior art “Cobra Head” style High Intensity Discharge (HID) street lamp assembly or luminaire 79 as installed on a utility pole 92. An incoming wire enters a transformer 80 that lowers the voltage to 120-240 Volts AC. This powers the HID lamp 10 (shown in FIG. 3) and causes rays of light 91 (shown in FIG. 2B) to illuminate the area below the lamp. Typically, this area is a roadway, intersection of roadways, sidewalk, park, parking lot, or the like.

A close up view of the prior art cobra head street lamp assembly 79 is shown in FIGS. 2A and 2B. Photocontrol 22 turns the light on and off according to the amount of ambient light. Such photocontrols or photosensors are well known in the art and will not be further discussed. Metal pole arm 14 can be seen entering into the luminaire 79. A dispersion lens 16 can be seen in FIG. 2B. A section line A-A is drawn on FIG. 2A showing the parting line for a detailed section views in FIGS. 3 and 4.

FIG. 3 shows section A-A in a semi-exploded view. This is done for clarity reasons to better illustrate how the internal components fit together. In this figure, one can see that a pole arm 14 typically enters into a hollow top housing assembly 12 via an oversized hole 39 and up against a pole arm end stop 30 usually cast into the top housing assembly 12. Power wires then connect to a terminal block 28 on the inside and then a transformer 19 and igniter 18 before connecting to an HID bulb base 31 and lamp 10. Lamp 10 is sometime referred to as a “bulb.” The transformer 19 and igniter 18 in this case represent an HID “starter” assembly, but can comprise of different electrical components such as circuit boards and other common components known to the art. The HID lamp 10 is then powered and “lit up” due to the controlled inrush current of the starting mechanism. Rays of light then exit the HID bulb and reflect off of the reflecting surface 29 of reflector housing 11. These rays are then dispersed through lens 16 to the ground to form an illuminated pattern.

Lens 16 is mechanically held in place by the bottom housing 13 which both opens rotationally around and is held in place by a hinge joint 33 & 34 and a spring loaded latch 20 to the top housing 12. A fiberglass or similar based gasket 17 is sandwiched in between the lens 16 and the HID bulb reflector 11. This helps seal the two pieces and prevents debris material and other objects from getting into the cavity and obscuring the lens. The top housing 12 is secured to the pole arm via a clamp 15 that is attached by turning one or more threaded fasteners 24 to a desired torque level into mating, internally threaded stud posts 32 that are usually cast into and part of the top housing 12. This keeps the clamp secured and the fasteners from backing out. It also prevents the HID lamp assembly 79 from shifting on the pole arm 14.

FIG. 4 shows section A-A in an assembled view. Some of the common pests found inside prior art cobra head street lamps are shown in FIG. 4, namely squirrel 26 and wasp 27. For instance, a squirrel can easily enter the housing via the center of a pole arm 14 or through the oversized gap 39 surrounding the pole arm 14. These pests are problematic in that they can contribute to the premature failure of the HID fixture causing costly unscheduled maintenance and can attack the maintainers as they are trying to perform maintenance on the fixture.

These pests find the inside of a streetlamp an ideal nesting habitat as it offers protection from the weather and predators. The flying squirrel's body is highly flexible and can easily squeeze into tight places. The flying squirrel, as with many rodents, has a tendency to chew through various objects with sharp, elongated teeth. The electrical wiring within the lamp is particularly vulnerable. Once a wire is chewed through, the center conductor is separated and exposed. In addition to causing the lamp to fail, this condition can cause a short to the housing 12 & 13. This can lead to a potential fire and electrical hazard. Squirrels can chew through and remove the fiberglass gasket 17 for nesting material. These animals can also create a mess by emitting feces and urine inside the lamp, which is unsanitary and can obscure the lens 16. It is therefore desirable to create a lamp that resists these types of pests.

Another common pest is the wasp 27 of which there are many varieties. The wasp is highly territorial and protects itself and its nest by injecting venom via stinger. Most varieties find the inside of a streetlight a desirable habitat for nesting purposes. In addition to entering into the lamp through the hole or gap 39 as the flying squirrel, the wasp can also enter through the parting line 38 formed by the top and bottom housings 12 & 13. Many wasp species form colonies and build hive nests 36 which are usually attached to the roof of the cavity inside the lamp. These nests can be large and the wasps inside are very aggressive to anything they see as a threat or intruder to their hive nest. They use their painful stinger to inject venom into anything they perceive as threatening their nest. They also simultaneously emit chemical signals to the other wasps in the nest to swarm and “attack” any threat in the area of the nest in a group. This is a common nuisance experienced by maintainers who frequently get stung trying to access a lamp fixture. Due to the fact that wasp stings are very painful and potentially lethal to those that are allergic to wasp venom, it is therefore desirable to create a lamp that resists these types of pests as well.

Current pest countermeasures such as makeshift screens are usually ineffective as persistent pests can chew through or squeeze around these crude devices.

The use of LEDs to replace common glass envelope lamps or bulbs is also known in the illumination arts. Earlier methods for packaging LED's includes a base containing five LED dies surrounded by a clear epoxy that allows rays of light to pass through. At the same time, this clear epoxy seals the LED's from moisture and other contaminants such as disclosed in U.S. Pat. No. 6,812,481.

U.S. Pat. No. 7,267,459 provides a hollow extruded enclosure surrounding one or more LED's and covered by a clear transparent sheet for the purpose reducing the ability for moisture and other contaminants from entering internally to the assembly.

### SUMMARY

In contrast to the above-described conventional approaches, embodiments of the invention are directed to a light emitting fixture or luminaire that is sealed from the outside and possesses no major voids within. This arrangement protects the light emitting elements, which may consist of Light Emitting Diodes (LEDs) with optical lenses, from the elements as well as keeping pests and vandals from inhabiting and/or causing damage to the luminaire. The optical lenses have high impact resistance, thus improving safety and reliability. The luminaire is easy and quick to install; it can be installed using only one hand tool, and can easily be handled with thick gloves.

One embodiment of the invention is directed to a luminaire, comprising a thermally conductive housing and a plurality of light emitters encased in a reflective solid matrix. Each light emitter comprises a light source and a lens element coupled thereto. The luminaire is mounted on a standard street lighting pole arm by means of a pole arm mounting formed integral to the housing. The pole arm mounting includes one or more captivated screw/band clamps to attaching the luminaire to the pole arm

A connector mounted on the pole arm end of the housing and adjacent to the pole arm mounting includes a plurality of conductors disposed to conduct electricity from a plurality of terminals located outside the housing to a plurality of connection points located inside the housing. The pole arm surrounds the connector and butts against the end of the housing when the luminaire is attached to the pole arm.

In an alternate embodiment, the luminaire housing comprises a heat sink. There may also be located within the housing a power supply that is thermally coupled to the housing and electrically coupled to the external (line) power and the light emitters. The electrical coupling from the external line power may, in some embodiments, be by means of a connector. This connector may have a pair of edge protrusions disposed in an I-shape that separates the wire terminals to prevent short circuits.

In a further embodiment, the connector may instead have a pair of edge protrusions disposed in a back-to-back C-shape for separating the terminals with a greater degree of protection from short circuits. And in yet a further alternate embodiment, the connector may be formed of an insulating material that substantially encloses the external terminals.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a prior art luminaire and how it is installed on a pole.

FIGS. 2A and 2B illustrate the parts of a prior art luminaire in top and side views, respectively.

FIG. 3 shows an exploded section view of a prior art luminaire.

FIG. 4 shows an assembled section view of a prior art luminaire infested with pests.

FIGS. 5A through 5E illustrates one embodiment of the present invention showing top, side, bottom, section, and rear views of the entire assembly.

FIG. 6A illustrates a close-up section of one embodiment of the present invention detailing a plurality of LEDs mounted to a thermally conductive board which is mounted to a thermally conductive housing. FIG. 6B is an expanded view of one such LED.

FIG. 7 illustrates an exploded, isometric view of an exemplary embodiment of the present invention as installed in the field.

FIG. 8 shows an isometric view of an exemplary embodiment connected to its electrical supply leads, with the pole arm removed.

FIG. 9 shows an exemplary embodiment mounted on the pole arm.

FIG. 10 shows a section view of the power connection point, according to one embodiment of the present invention.

FIGS. 11A-11B, 12A-12B, and 13A-13B show several alternate embodiments of the power connection point.

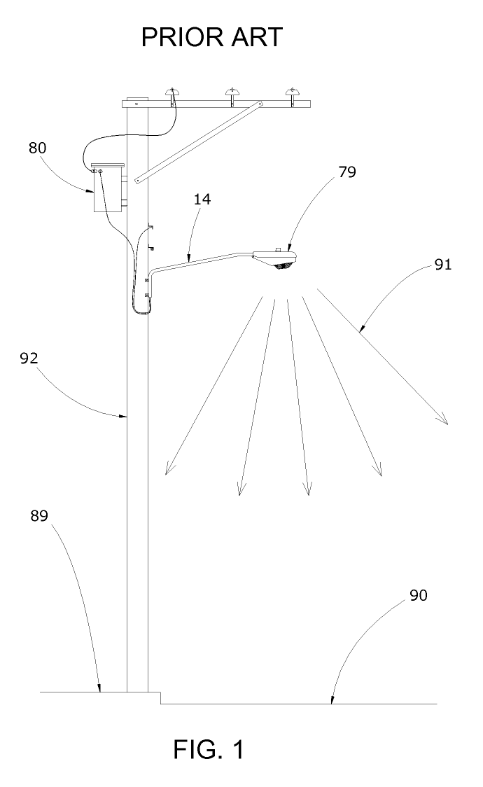

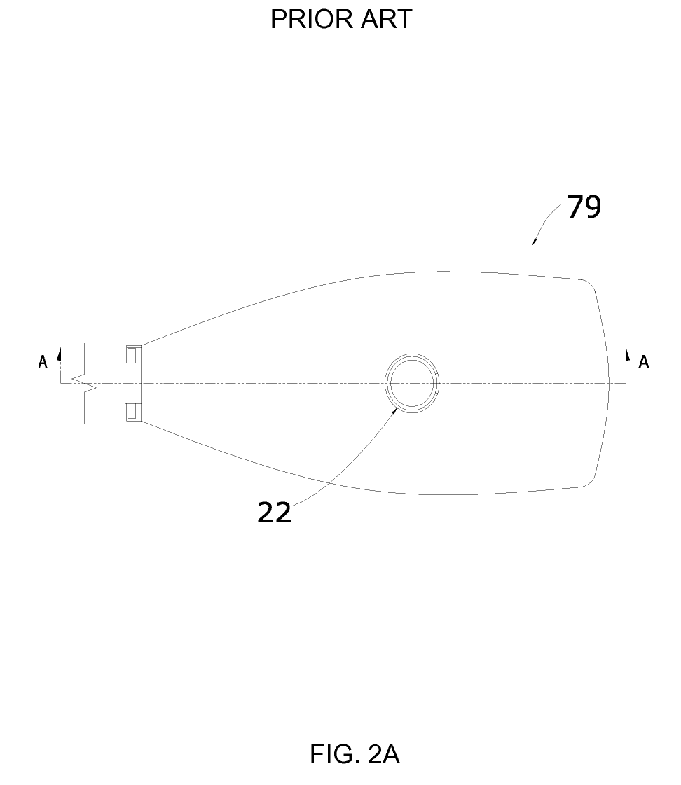

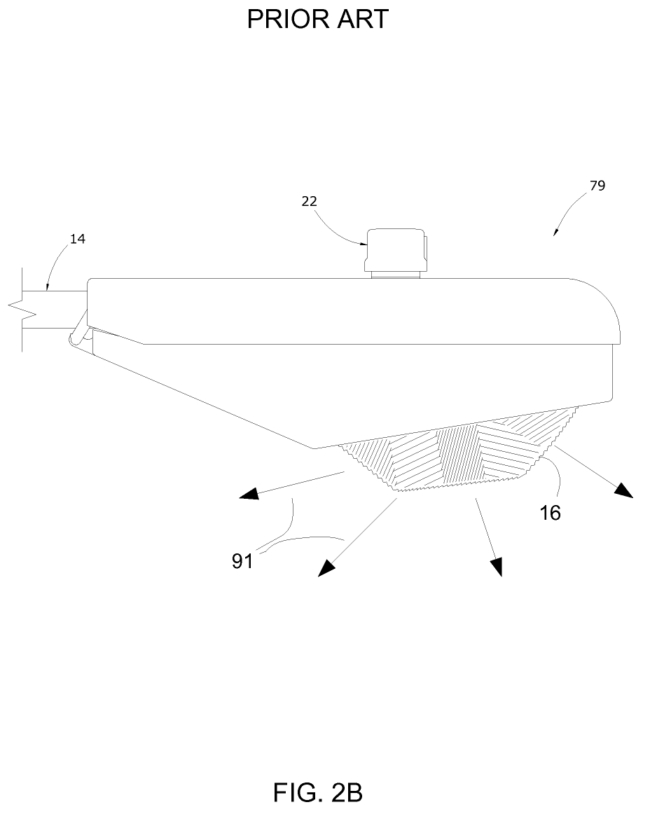

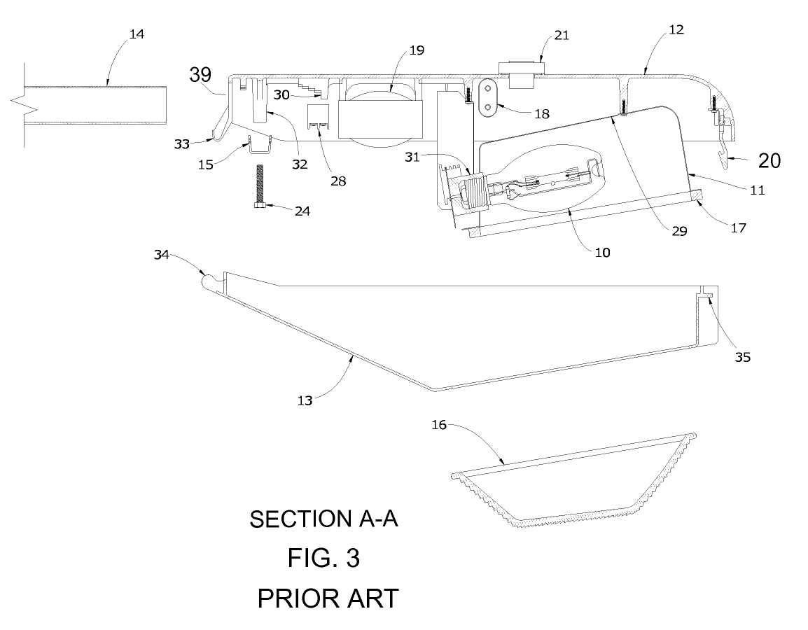

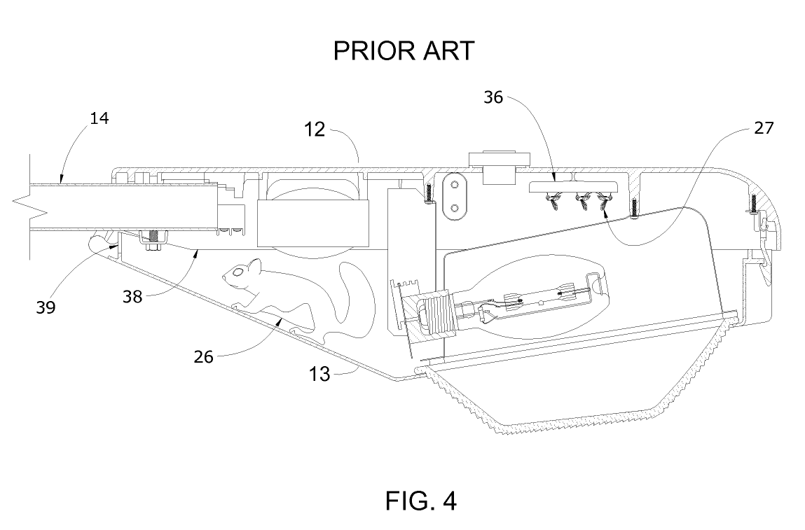

### DETAILED DESCRIPTION

The present invention is a novel pest resistant streetlamp assembly that is also more affordable and easier to install and maintain than current lighting technology. This is accomplished by using a completely sealed lamp assembly with no large internal voids and with an innovative mounting technique to accommodate various pole arm diameters.

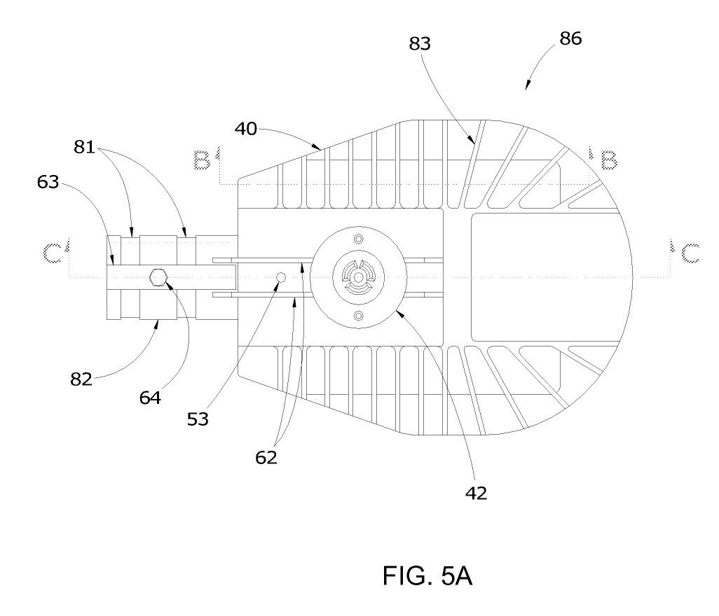

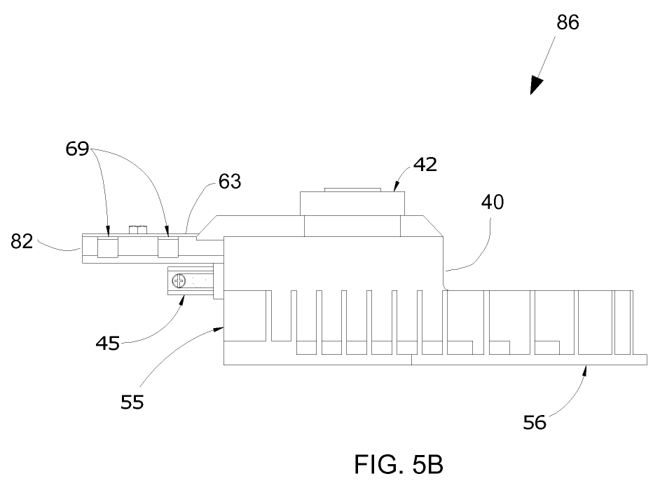

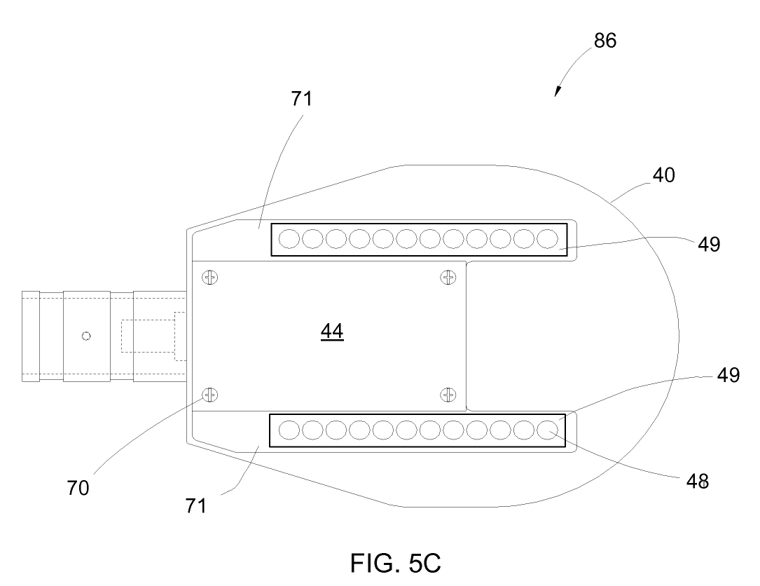

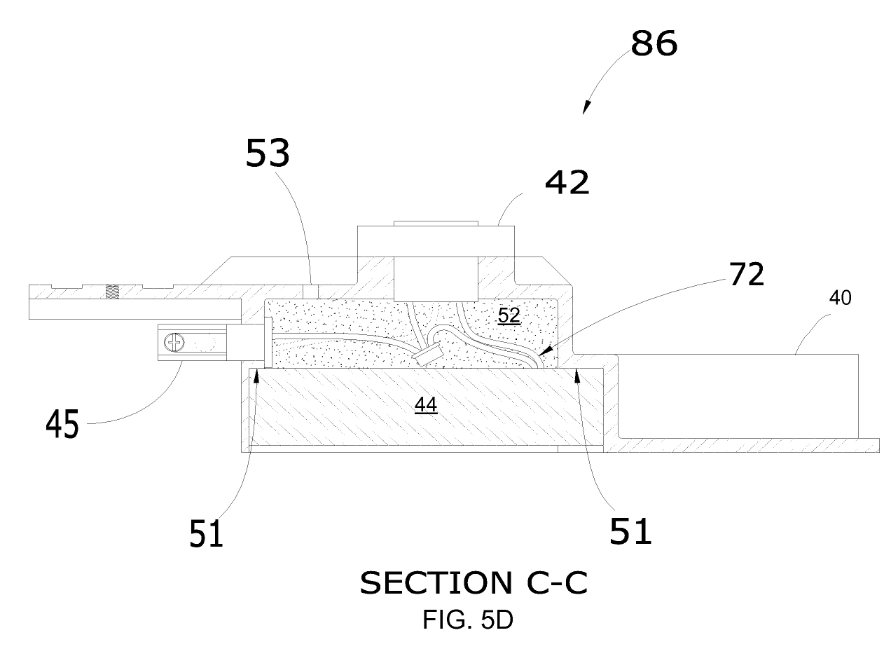

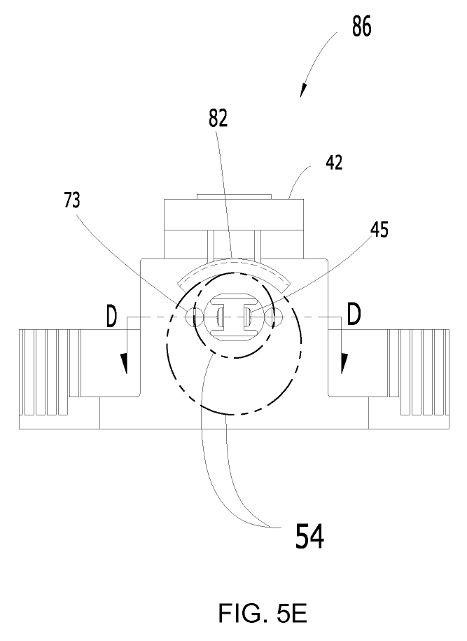

FIGS. 5A, 5B, 5C, 5D, and 5E show the embodiment of said invention from top, side, bottom, section, and rear views, respectively. This embodiment of the invention will hereto be referred to as the pest resistant lamp (PRL). The entire assembly 86 consists principally, but not exclusively, of a main housing 40 that is machined, cast, or stamped from a thermally conductive metal such as (but not limited to) zinc, copper, aluminum, or alloys thereof. This serves as a structural “skeleton” of the lamp as well as to draw heat away from the power supply and Light Emitting Diodes (LEDs, or singularly, LED). LEDs are preferable over HID bulbs as they generate less heat during operation and are more power efficient.

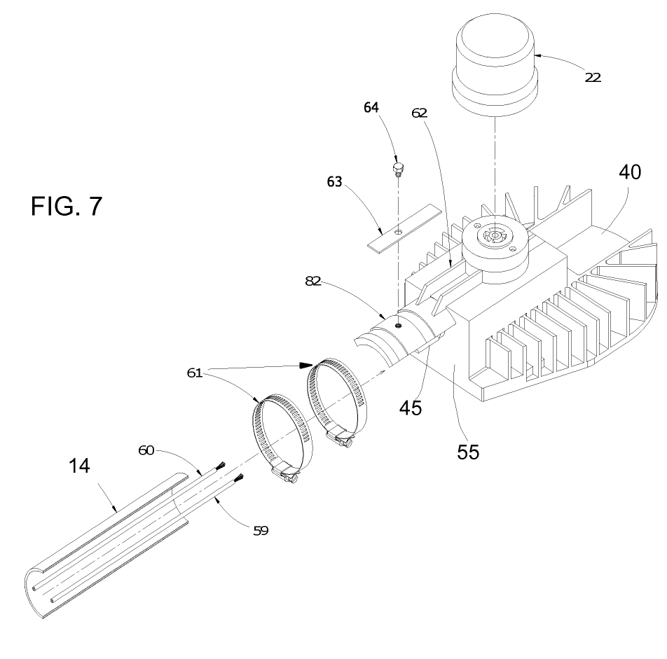

FIG. 5A shows the top view of the PRL housing and illustrates the general shape of the luminaire assembly. The stainless steel screw/band mounting clamps 61 (referring to FIG. 7) is removed for clarity. Radiating fins 83 allow excess heat to escape from the assembly. A pour hole 53 is drilled out or cast into the top of the assembly. A photocontrol receptacle 42 for holding an industry standard photocontrol is also shown. This may be, in some embodiments, the same photocontrol receptacle as commonly used in the prior art. A protrusion 82 is shown on the side of the housing 40. Protrusion 82 is hereto referred to as the “pole arm to housing mounting arm.” The pole arm to housing mounting arm 82 mounts to the top of the incoming pole arm (not shown) and serves as a support for the stainless steel screw/band clamp (not shown for clarity) known in the prior art. Two clamp grooves 81 are shown in the pole arm to housing mounting arm 82. A clamp-retaining bracket 63 is held down via a threaded fastener 64. Two top support fins 62 provide structural support to the pole arm housing mounting arm 82 in addition to keeping the clamp retaining bracket from rotating around pole arm housing mounting arm 82, since the clamp retaining bracket is only held down by one fastener 64.

FIG. 5B shows the side view of the PRL assembly. An “I” shaped power connection point (or simply “connector”) 45 is shown underneath the pole arm housing mounting arm 82. Two clamp gaps 69 between pole arm to housing mounting arm 82 and clamp retaining bracket 63 are also seen in this view. The clamp gaps are each large enough to accommodate one or more stainless steel screw/band mounting clamps (not shown) and to allow rotational motion of the clamp for installation purposes, but not to allow the clamps to escape or fall off. This allows the clamps to be held in a “captive” state. A flat surface 55 perpendicular to the “I” shaped connector 45 allows for flush mounting of the end of the pole arm so that pests have no gaps near the lamp assembly from which to enter or hollow overhangs to create nests. The bottom surface 56 is, in an exemplary embodiment, flat and perpendicular in relation to flat surface 55. In alternate embodiments, however, there needs be no restriction on the shape of bottom surface 56.

Although an embodiment using two clamps 61 is described, those skilled in the art will realize that any number of clamps can also be used. Accordingly, the invention is not limited to any particular number of clamps.

Although “I” shaped power connection point or connector is described, those skilled in the art will realize that connectors other than an “I” shaped connector can be used. Accordingly, as will be discussed further below, the invention is not limited to any particular type or shape of power connection point.

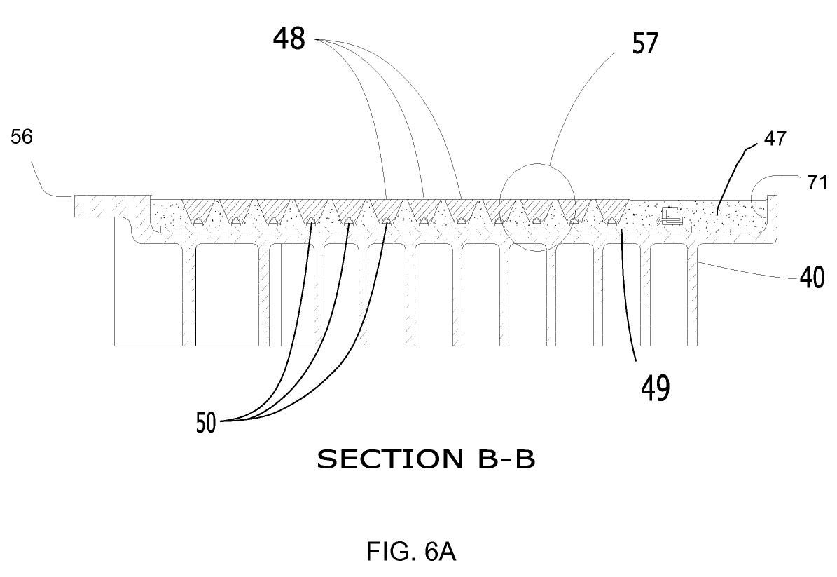

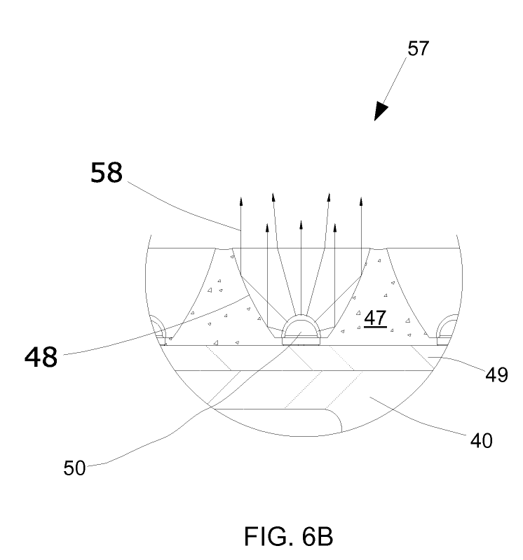

FIG. 5C shows the bottom (i.e., the ground- or street-facing side) of the PRL assembly 86. The bottom of encapsulated power supply 44 is shown in the center of the PRL. The bottom of the power supply 44 is flush or near flush with the bottom 56 of the main housing 40. This helps to form cavities 71 in the bottom of the housing for mounting an LED MCPCB strip 49, which are then back filled with white reflective epoxy. Each LED MCPCB strip 49 contains a plurality of LED lens assemblies 48, discussed in further detail below with reference to FIGS. 6A and 6B.

Encapsulated power supply 44 may be any commercially available power supply suitable for adapting the input line voltage to the voltage or voltages required to operate LEDs 50. Alternatively, a special purpose power supply may be used to optimize the power consumption of the luminaire. As the type, specification, and design of such a power supply, as well as methods of encapsulating or otherwise weatherproofing the same, are well known in the art, the details of the power supply 44 will not be further discussed herein. In a further alternate embodiment, the functions of power supply 44 may be distributed to and located on each LED MCPCB strip 49, eliminating the need for a separate power supply device. In such an embodiment, wire harness 72 connects from connector 45 directly to each LED MCPCB strip 49.

Although two LED MCPCBs 49 are shown, one of ordinary skill in the art will appreciate that a single LED MCPCB 49 or three or more LED MCPCBs 49 (with corresponding cavities 71 formed in the bottom 56 of min housing 40) may also be used, depending on the light output desired. Accordingly, the invention is not limited to any particular number or arrangement of LED MCPCBs 49 or cavities 71 within housing 40. Similarly, the invention is not limited to any particular number or arrangement of LED lens assemblies 48 within each LED MCPCB 49.

The power supply 44 is mounted to the main housing using threaded, riveted, or other fasteners 70 commonly known in the art. The power supply can also have a thin coating of epoxy or other weatherproof material for additional protection, preferably a white reflective epoxy. Such a coating will resist light arms fire from air rifles and slingshots that vandals typically use to intentionally destroy streetlights as epoxy has high shock absorption properties. Even if an individual LED lens 48 were penetrated, it would only short out the individual LED, which is wired in parallel, thus not causing the whole lamp to go dim. This would make it extremely difficult and frustrating, albeit not impossible, for a vandal to completely destroy and dim out the lamp.

FIG. 5D shows a section view C-C (referring to FIG. 5A) of the PRL 86 with clamps 61, clamp retaining bracket 63, and fastener 64 removed for clarity. The “I” shaped connector 45 feeds through the main housing 40 and connects to the photocontrol receptacle 42 and encapsulated power supply 44 via an internal wire harness 72. The encapsulated power supply 44 is mounted to the housing via standard fasteners (not shown). A bead of thermal epoxy compound or adhesive 51 is placed around the perimeter of the power supply 44 to bond it to a shelf that is formed by the housing 40. This seals off and creates an internal cavity that contains internal wire harness 72. This internal cavity is then filled with an electrically insulating, thermally conductive epoxy compound 52 via a fill hole 53. This effectively removes all internal voids from the cavity, preventing pests from entering as well as moisture from causing damage to the wiring.

FIG. 5E shows a rear view of the PRL, looking from the pole arm into the luminaire 86. The “I” shaped connector 45 is shown from the end that first enters the hollow portion of the pole arm (not shown for clarity). The “I” connector mounting fasteners 73 are shown at both the right and left sides of the “I” connector 45. These fasteners 73 are mounted flush to the rear housing surface 55. Any of a number of flush-mounting fasteners well known in the art may be used. This ensures that the end of the pole arm 14 remains flush to the housing surface. Outlines of the minimum and maximum pole arm diameters are shown as phantom lines 54. Pole arm sizes vary, so it is important for the mounting connection to accept a wide range of sizes.

FIG. 6A illustrates a close-up along Section B-B of FIG. 5A of one embodiment of the present invention detailing a plurality of Light Emitting Diodes (LEDs) 50 mounted to a thermally conductive MCPCB 49 which is mounted to thermally conductive housing 40. The Light Emitting Diodes are placed under precision optical lenses 48 which are surrounded by a white reflective epoxy 47.

In particular, FIG. 6A shows a cross-section of one of the LED MCPCB arrays 49. A cavity 71 is formed in the housing 40 by any of a number of means well known in the metalworking arts, such as casting or milling. A plurality of LED's 50 are mounted to a Metal Core Printed Circuit Board (MCPCB) 49. Clear acrylic, polycarbonate, Lexan® or similar lenses 48 cover each of the LED's 50 and direct the light in a specific pattern. (Only three lenses 48 are shown for clarity; all LEDs 50 are covered by such lenses.) The entire cavity 71 is then filled with a white reflective epoxy 47. The epoxy is filled until it is flush or near flush with surface 56. The smooth glossy surface of the epoxy and the overall flatness of the bottom deter nest building by wasps in addition to covering the LED MCPCB array and protecting it from weather elements.

FIG. 6B shows more detail of a LED lens assembly 57. An LED 50 emits light through a typical LED lens 48 commonly used in the art. While very efficient, errant light rays 58 can exit through the side of the LED lens 48. The white glossy epoxy 47 reflects these errant rays out of the top of the lens 48 (which is not covered by epoxy 47) thereby making the lens more efficient.

FIG. 7 shows an isometric exploded view of one embodiment of the present invention, with particular detail in one method of fastening it onto a pole arm 14. Wires 59 and 60 enter through the center of the pole arm 14 and are connected to “I” shape connector 45 through the clamps 61. Although only two wires 59, 60, and two clamps 61 are shown, one of ordinary skill in the art will recognize that multiple wires and/or multiple clamps may also be used. Accordingly, the present invention is not to be construed as limited to a specific number of wires and/or clamps. Also, although a stainless steel screw/band clamp is described in one preferred embodiment, those skilled in the art will realize that clamps other than screw/band clamps or made of materials other than stainless steel can be used. Accordingly, the invention is not limited to any particular type of clamp.

The end of the pole arm 14 is placed flush against the side 55 of the housing 40. The clamp retaining bracket 63 and fastener 64 holds the stainless steel screw/band clamps 61 in place on pole arm to housing mounting arm 82 while the maintainer connects the wires to “I” shaped connector 45, maneuvers the whole assembly into position and slides the housing 40 onto pole arm 14. The fact that clamps 71 hold the assembly on pole arm 14 while the electrical connections are made is important, as the maintainers must typically wear thick rubber electrically insulating gloves while installing the luminaire. Once the electrical connections are made, the maintainer slides the housing 40 inward on pole arm 14 until the end of pole arm 14 contacts flush surface 55 and tightens the stainless steel screw/band clamps 61 to secure the entire assembly in place.

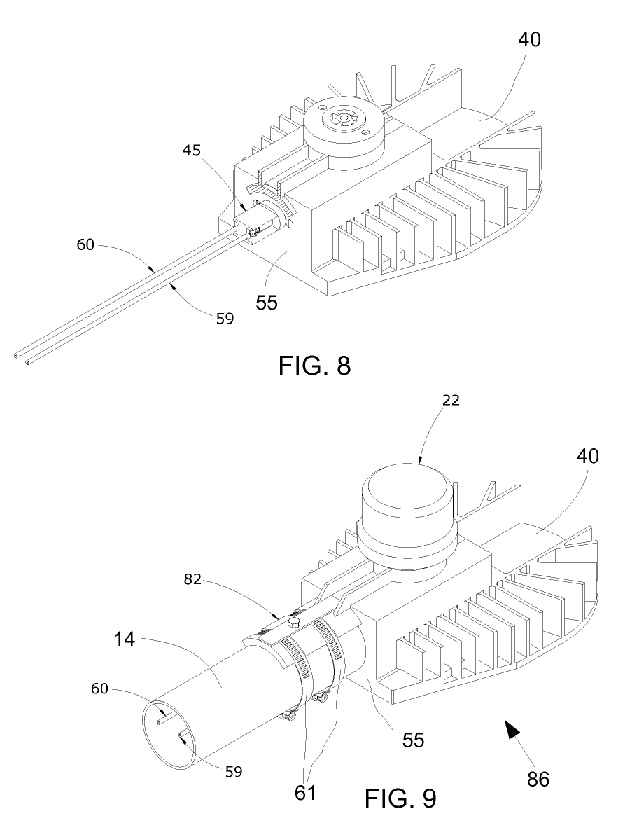

FIG. 8 shows the same isometric view of the assembly as in FIG. 7, but shows the “I” connector 45 in better detail. Pole arm to housing mounting arm 82, clamps 61, clamp retaining bracket 63, fastener 64, and photocontrol 22 are removed for clarity. FIG. 9 shows the fully assembled and installed luminaire 86, with photocontrol 22 installed on housing 40. Clamps 61 secure pole arm to housing mounting arm 82 to pole arm 14.

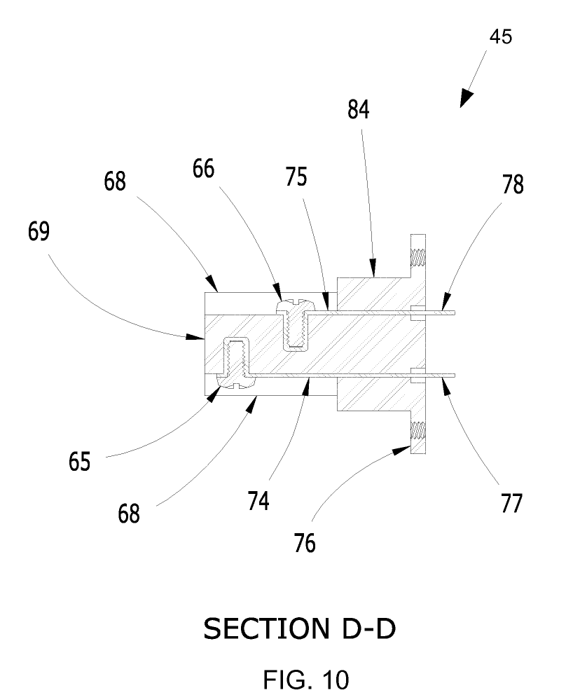

FIG. 10 shows a cross section view D-D (referring back to FIG. 5E) of the “I” connector 45, according to one embodiment of the present invention. The main body 84 of the connector 45 is made of an insulating material such as such as plastic or ceramic. Two input terminals 65 & 66 accept incoming power wires 59 & 60 (not shown). An edge protrusion 68 keeps the sides of the inside of the metal pole arm from touching the wires and causing a short during installation. These are present on both sides of input terminals 65 & 66 forming a distinctive “I” shape when seen on end, as in FIG. 5E. Both input terminals 65 & 66 have carrying conductors imbedded in the plastic or ceramic insulator body 84. These conductors come out at the opposite (housing) end forming connection points 77 & 78 for the wiring harness 72 (not shown) inside the housing 40. The carrying conductors 74 & 75 pass through a thickened portion of insulating body 84, which shields the conductors from the housing.

Screw terminal 65 is offset from screw terminal 66. This accomplishes two things: first, it reduces the likelihood of a short, as a stripped wire will be drawn in further down the side of the connector lessening the chance that stray wires will flex around the center portion 69 of insulator 84 and touch the other wire, thus causing a short. Secondly, the offset conserves space, allowing small pole arms to comfortably fit over the connector.

A mounting flange 76 on the end allows for attaching the entire connector 45 to the main housing 40 via threaded, riveted, or other fasteners 73 (shown in FIG. 5E) commonly known in the art.

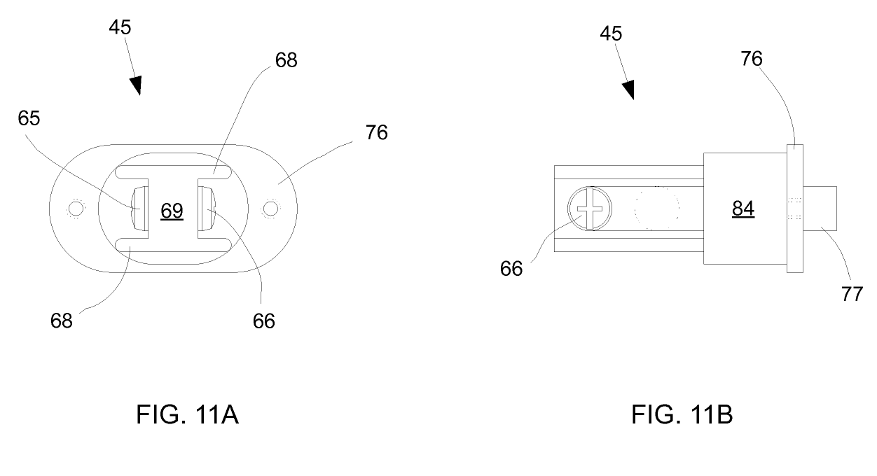

FIGS. 11A and 11B show side and front views, respectively, of the “I” connector according to one embodiment of the present invention.

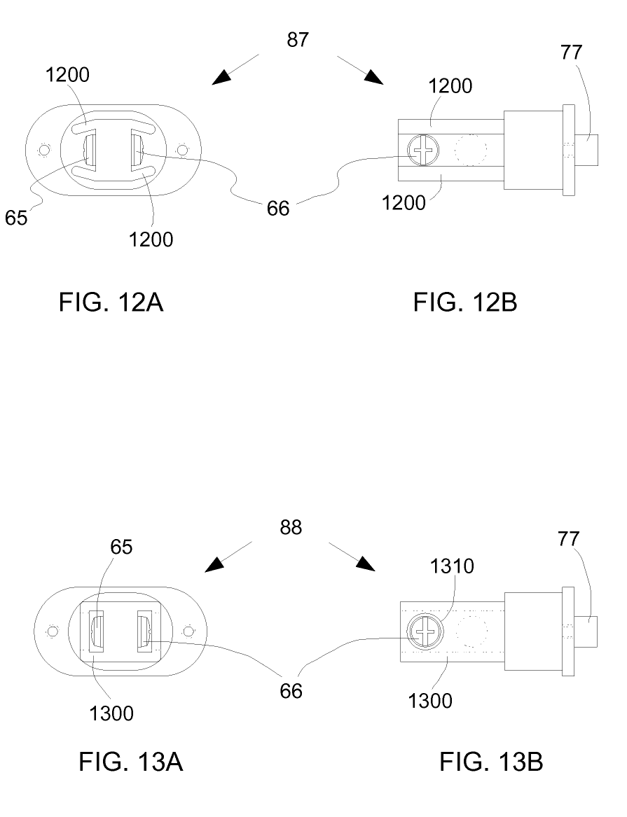

FIGS. 12A and 12B show side and front views, respectively, of a variation of connector 87 with the edge protrusions 1200 angled in towards input terminals 65 & 66. This configuration is referred to herein as a “back-to-back C-shape” arrangement of edge protrusions.

FIGS. 13A and 13B show side and front views, respectively, of a variation of connector 88 with edge protrusions 1300 that “box in” input terminals 65 & 66. The side view shows a hole 1310 placed over input terminal 66 so that the maintainer can access terminal screw 66 with a screwdriver.

While the above descriptions represent a preferred embodiment of the present invention, it should be acknowledged that the invention may be modified in form and/or detail by those skilled in the art. Various other advantages of the present invention will become apparent to those skilled in the art after having the benefit of studying the foregoing text and drawings taken in conjunction with the appended claims. Accordingly, the appended claims encompass within their scope all such changes and modifications.

I claim:

1. A luminaire, comprising:
a thermally conductive housing;
a plurality of light emitters encased in a reflective solid matrix, said solid matrix having a bottom surface, wherein each said light emitter comprises a light source and a lens element coupled thereto, and wherein each said lens element is disposed substantially coplanar with each other said lens element and said bottom surface so that the light emitted exits from said bottom surface;
a pole arm mounting formed integral to said housing at a proximal end, comprising one or more captivated clamps for attaching said luminaire to a pole arm; and
a connector mounted on said proximal end of said housing adjacent to said pole arm mounting, comprising a plurality of conductors disposed to conduct electricity from a plurality of terminals located outside said housing to a plurality of connection points located inside said housing, wherein said pole arm surrounds said connector and butts against said proximal end of said housing when said luminaire is attached to said pole arm,
wherein said plurality of light emitters, when mounted in said housing, define a sealed space interior to said housing having no opening to the outside.

2. The luminaire of claim 1, wherein said housing comprises a heat sink.

3. The luminaire of claim 1, wherein said reflective solid matrix is white in color.

4. The luminaire of claim 1, wherein said reflective solid matrix substantially comprises epoxy.

5. The luminaire of claim 1, further comprising a power supply thermally coupled to said housing and electrically coupled to said plurality of connection points and said plurality of light emitters.

6. The luminaire of claim 1, further comprising a power supply integrally disposed with said plurality of light emitters.

7. The luminaire of claim 1, wherein said connector further comprises a pair of edge protrusions disposed in an I-shape separating said first plurality of terminals.

8. The luminaire of claim 1, wherein said connector further comprises a pair of edge protrusions disposed in a back-to-back C-shape separating said first plurality of terminals.

9. The luminaire of claim 1, wherein said connector substantially encloses said first plurality of terminals.

10. A luminaire, comprising:
a thermally conductive housing;
a plurality of light emitters encased in a reflective solid matrix, said solid matrix having a bottom surface, wherein each said light emitter comprises a means for producing light and a lens element coupled thereto, and wherein each said lens element is disposed substantially coplanar with each other said lens element and said bottom surface so that the light emitted exits from said bottom surface;
a means for pole arm mounting formed integral to said housing at a proximal end, comprising one or more captivated clamps for attaching said luminaire to a pole arm; and
a connector mounted on said proximal end of said housing adjacent to said pole arm mounting, comprising a plurality of conductors disposed to conduct electricity from a plurality of terminals located outside said housing to a plurality of connection points located inside said housing, wherein said pole arm surrounds said connector and butts against said proximal end of said housing when said luminaire is attached to said pole arm,
wherein said plurality of light emitters, when mounted in said housing, define a sealed space interior to said housing having no opening to the outside.

11. The luminaire of claim 10, wherein said housing comprises a heat sink.

12. The luminaire of claim 10, wherein said reflective solid matrix is white in color.

13. The luminaire of claim 10, wherein said reflective solid matrix substantially comprises epoxy.

14. The luminaire of claim 10, further comprising means for supplying power thermally coupled to said housing and electrically coupled to said plurality of connection points and said plurality of light emitters.

15. The luminaire of claim 10, further comprising means for supplying power integrally disposed with said plurality of light emitters.

16. The luminaire of claim 10, wherein said connector further comprises a pair of edge protrusions disposed in an I-shape separating said first plurality of terminals.

17. The luminaire of claim 10, wherein said connector further comprises a pair of edge protrusions disposed in a back-to-back C-shape separating said first plurality of terminals.

18. The luminaire of claim 10, wherein said connector substantially encloses said first plurality of terminals.
